(19) United States
(12) Patent Application Publication
(10) Pub. No.: US 2014/0085431 A1
(43) Pub. Date: Mar. 27, 2014

(54) OPTICAL ELEMENT, OPTICAL SYSTEM AND IMAGE PROCESSING METHOD

(71) Applicant: SONY CORPORATION, Minato-ku (JP)

(72) Inventors: Volker FREIBURG, Stuttgart (DE); Dennis Harres, Stuttgart (DE); Zoltan Facius, Stuttgart (DE)

(21) Appl. No.: 13/928,677

(22) Filed: Jun. 27, 2013

(30) Foreign Application Priority Data
Sep. 21, 2012 (EP) 12006640.2

(51) Int. Cl. H04N 13/02

(52) U.S. Cl. CPC H04N 13/0242
USPC 348/48

(57) ABSTRACT

An optical element (100), comprises a first surface (110) having a first reflective coating (310) having a first reflectivity greater than 0 and smaller than or equal to 100% in a first wavelength range, and a second surface (120) having a second reflective coating (320) having a reflectivity greater than 0 and smaller than or equal to 100% in a second wavelength range, wherein a portion of the second wavelength range does not lie in the first wavelength range and the first and second surface are aligned along a first and a second plane, respectively, the first and second plane intersecting at an angles a smaller than 90° and greater than 0°.

### BACKGROUND

The present disclosure relates to an optical element and to an optical system. Further, the disclosure relates to an image processing method.

In the field of stereovision/multi-view, generally, optical systems are built by arranging a multitude of cameras (at least two) side-by-side on a rig. According to an alternative, the multitude of cameras may be disposed at a transmittance side and at a reflecting side of a mirror so as to separate the images. In a side-by-side arrangement, the lateral extension of the cameras generally provides a minimum separation of the cameras along a so-called “base line”. This separation generally results in a different fields of view of the cameras.

Moreover, recently, 3-D cameras have been employed in order to get three-dimensional images. For example, such a 3-D camera may be implemented as a time-of-flight (TOF) camera so as to measure the distance of the viewed objects in the third dimension.

Accordingly, it is desirable to develop a new optical element and a new optical system in order to arrange a plurality of cameras.

It is an object of the embodiments to provide an optical element, by which an optical system can be implemented in which a plurality of cameras may be disposed and which at the same time has a compact low-weight size.

### SUMMARY

The above objects are achieved by the claimed matter according to the independent claims. Those skilled in the art will recognize additional features and advantages upon reading the following detailed description and on viewing the accompanying drawings.

### BRIEF DESCRIPTION OF THE DRAWINGS

The accompanying drawings are included to provide a further understanding of the invention and are incorporated in and constitute a part of this specification. The drawings illustrate the embodiments of the present invention and together with the description serve to explain principles of the invention. Other embodiments of the invention and intended advantages will be readily appreciated as they become better understood by reference to the following detailed description.

FIG. 1A illustrates an optical element according to an embodiment.

FIG. 1B illustrates an optical element according to a further embodiment.

FIG. 2 illustrates an optical system according to an embodiment.

FIG. 3 illustrates a transmission characteristic of the optical element illustrated in FIGS. 1A and 1B, respectively.

FIG. 4 illustrates steps of an embodiment of a method of processing a light beam.

### DESCRIPTION OF THE EMBODIMENTS

In the following detailed description, reference is made to the accompanying drawings, which form a part hereof, and in which are shown by way of illustrations specific embodiments in which the invention may be practiced. It is to be understood that other embodiments may be utilized and structural or logical changes may be made without departing from the scope of the present invention. In this regard, directional terminology such as “top”, “bottom”, “front”, “back”, “leading”, “trailing” etc. is used with reference to the orientation of the Figures being described. Since components of embodiments of the invention can be positioned in a number of different orientations, the directional terminology is used for purposes of illustration and is in no way limiting. It is to be understood that other embodiments may be utilized and structural or logical changes may be made without departing from the scope defined by the claims.

The description of the embodiments is not limiting. In particular, elements of the embodiments described hereinafter may be combined with elements of different embodiments. For example, features illustrated or described for one embodiment can be used on or in conjunction with other embodiments to yield yet a further embodiment. It is intended that the present invention includes such modifications and variations. The examples are described using specific language which should not be construed as limiting the scope of the appending claims. The drawings are not scaled and are for illustrative purposes only. For clarity, the same elements have been designated by the same references in the different drawings if not stated otherwise.

The terms “having”, “containing”, “including”, “comprising” and the like are open and the terms indicate the presence of stated structures, elements or features but not preclude additional elements or features. The articles “a”, “an” and “the” are intended to include the plural as well as the singular, unless the context clearly indicates otherwise.

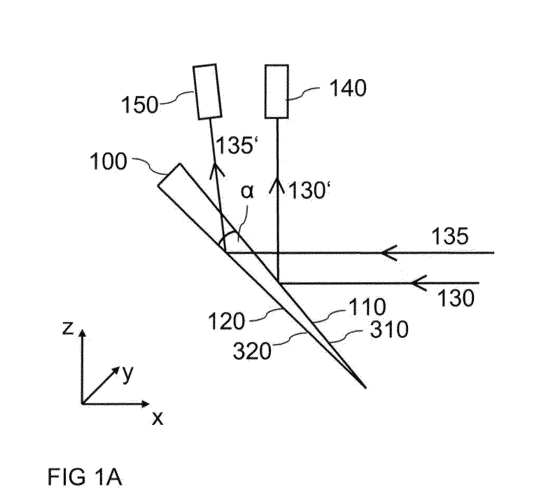

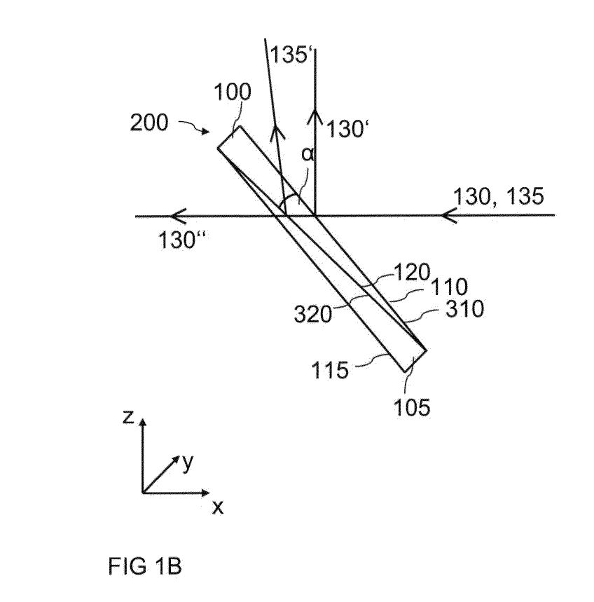

FIG. 1A illustrates an embodiment of an optical element 100. The optical element 100 comprises a first surface 110 and a second surface 120. The first surface 110 and the second surface 120 are aligned along a first and a second plane, respectively, the first and second plane intersecting at an angle α smaller than 90° and larger than 0°. Although FIG. 1A illustrates a case in which the first surface 110 intersects the second surface 120, and the optical element has the shape of wedge, the optical element 100 may as well have the shape of a trapezoid. A first reflective coating 310 is disposed on the first surface 110, and a second reflective coating 320 is disposed on the second surface 120. The first reflective coating 310 has a first reflectivity greater than 0 and smaller than of equal to 100% in a first wavelength range, and the second reflective coating 320 has a reflectivity greater than 0 and smaller than to or equal than 100% in a second wavelength range. In FIG. 1A, light beam 130 denotes a light beam in a first wavelength range, and light beam 135 denotes an incident light beam having a wavelength in the second wavelength range, the wavelength of the light beam 135 lying outside the first wavelength range. The second wavelength range comprises a portion which is not included in the first wavelength range. In other words, light having a wavelength within the first wavelength range is reflected to a specific amount corresponding to the reflectivity of the first reflective coating 310 to form a reflected light beam 130′. Moreover, light beam 135 in the second wavelength range is transmitted by the first reflective coating 310 and reflected by the second reflective coating 320 at an amount corresponding to the second reflectivity to form a reflected light beam 135′.

Accordingly, depending on the wavelength of an incident light beam, the reflected light beam may be directed towards sensor 140 or sensor 150. Accordingly, depending in the wavelength of an incident light beam 130, 135, an incident light beam may be shifted by the optical element 100 along the x-direction, the x-direction corresponding to the light entrance direction. Although FIG. 1A shows a separation of light beams 130, 135 along the z-direction which is for a better distinction of the different light beams, it is clear that the light beams 130, 135 may propagate along the same z-coordinate.

According to an embodiment, the first reflective coating 310 has a light transmittance in the second wavelength range, for example 100%. Further, the second reflective coating 320 has a light transmittance in the first wavelength range, for example 100%. For example, the reflective coatings 310, 320 may be implemented by suitable dielectric layer stacks or layer stacks in which due to interference the desired transmission and reflexion properties are implemented.

According to a different interpretation, the optical element 100 is configured to reflect an incident light beam at different angles, the angles depending on a wavelength of the light. In particular, a first portion of an incident light beam having a wavelength in a first wavelength range (corresponding to light beam 130) is reflected at a first reflection angle, and a second portion of the incident light beam having a wavelength in a second wavelength range (corresponding to light beam 135) is reflected at a second angle. For example, the first wavelength range may be the visible wavelength range, e.g. from 400 to 700 nm. The second wavelength range may be a range other than the first wavelength range, for example comprise the IR (infrared) range, e.g. may be larger than 800 nm and less than 1100 nm.

FIG. 1B shows an optical compound element 200 according to a further embodiment. The optical compound element 200 shown in FIG. 1B comprises a first optical element 100 as illustrated in FIG. 1A and a second optical element 105. The second optical element 105 may have a similar shape as the first optical element. Nevertheless, no reflective coatings may be disposed on the second optical element 105. The optical elements 100, 105 are combined to form a plane parallel plate, so that the first surface 110 of the first optical element 100 and the back side 115 of the second optical element 105 are parallel to each other. For example, the two optical elements 100, 105 may be glued by a common glue.

Accordingly, a light beam 130 in a first wavelength range is reflected by the optical compound element 200 according to a reflectivity R₁(λ) of the first reflective coating 310 to form a reflected beam 130′. Another portion of the incident light beam 130 is transmitted by the first reflective coating 310 and the second reflective coating 320 to form a transmitted light beam 130″. The intensity of the reflected light beam 130′=R₁(λ₁)·I₁, wherein R₁(λ₁) denotes the reflectivity of the first reflective coating 310 in the first wavelength range and I₁ denotes the intensity of the light beam 130 in the first wavelength range. The intensity of the transmitted light beam corresponds to (1−R₁(λ₁))·(1−R₂(λ₁))·I₁, wherein 0≦R₁,R₂≦1, and R₂(λ₁) denotes the reflectivity of the second reflective coating 320 in the first wavelength range. Further, light 135 in the second wavelength range is transmitted by the first reflective coating 310 and is reflected by the reflective coating 320 to form a reflected light beam 135′. For example, the reflectivity R₁(λ₁) of the first reflective layer may lie in a range from 40 to 60% for light in the first wavelength range and may be about 50%, for example. Moreover, the reflectivity R₂(λ₂) of the second reflective coating may be more than 90% for light in the second wavelength range, for example, 99 or even 100%.

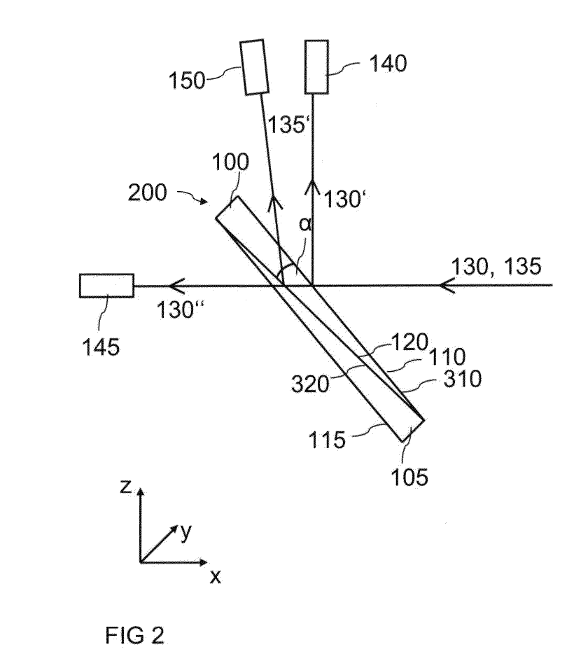

FIG. 2 illustrates an optical system according to an embodiment. The optical system shown in FIG. 2 comprises at least a first sensor 140 and a third sensor 145, both operating in the first wavelength range. Any of the optical sensors 140, 145 may comprise a plurality of sensors. The first sensor 140 is disposed on a reflecting side of the optical element 200, the reflecting side of the optical element 200 corresponding to the light entrance side of the optical element 200. Further, the third sensor 145 is disposed on the light transmittance side of the optical element 200, the light transmittance side of the optical element 200 being opposed to the reflecting side of the optical element 200. The optical element 200 may correspond to the optical element 200 illustrated in FIG. 1B.

The optical system shown in FIG. 2 further comprises a second sensor 150. The second sensor 150 is shifted along the x-direction with respect to the first sensor 140. The second sensor 150 is disposed at a reflecting side of the optical element 200. The second sensor 150 operates in a second wavelength range, the second wavelength range comprising a portion which does not lie in the first wavelength range.

As has been explained with reference to FIG. 1A, an incident light beam 130, 135 is separated along the x-direction depending on whether the light has components in the first or second wavelength range. Accordingly, light in the second wavelength range is reflected by the second reflective coating 320 to arrive at the third sensor 150 and light in the first wavelength range is reflected by the first reflective coating 310 to arrive at the first sensor 140.

Any of the first, third and second sensors 140, 145, 150 may be a commonly used sensor or may be a camera as is commonly employed. In the following description, the terms “sensor” and “camera” are used. As is to be clearly understood, these terms may be interchanged, since a sensor may be operated in a similar manner as a camera. In particular, an external light source may be provided so that the functionality of a camera may be realized.

For example, the first and third sensors 140, 145 may operate with visible light having a wavelength of 400 to 700 nm. Likewise, the first reflective coating 310 works in the visible wavelength range. Moreover, the second wavelength range may comprise the NIR (near infrared) range of 800 to 900 nm. Accordingly, the second sensor 150 may work in the NIR range. Moreover, the first and third sensors 140, 145 may be high-resolution 2-D cameras, and the second sensor 150 may be a 3-D camera which is configured to provide a three-dimensional image. According to an embodiment, the second sensor 150 may be a TOF camera.

The optical system shown in FIG. 2 enables stereovision using cameras with adaptable baseline, which is not limited by the mechanical outline of the camera. In particular, the optical element implements a compact single element beam combiner. Since at least two sensors are arranged on the same optical axis, easier matching between the images may be accomplished.

The arrangement shown in FIG. 2 enables to align at least three high-definition cameras with an additional 3-D camera at the same optical axis and sharing the same field of view. All shown cameras may be synchronized to have a temporal alignment of the image sequences. Further, the cameras may have adapted lens systems so as to have the same field of view or at least the same horizontal span. In particular, due to the special configuration of the optical element 200, the sensor 150 may be aligned on-axis with the first sensor 140. In particular, both sensors have the same field of view. Since the first and second sensors 140, 150 are arranged side-by-side, it is not necessary to provide an additional coupling mirror for the sensor 140. As a result, a compact multi-view camera system comprising a 3-D range camera can be provided. Further, a 3-D range camera provides measured distance/depth information which may facilitate an artificial computation of depth information from disparity in either 2 or more images from 2-D cameras.

In the illustrated embodiments, the angle a between a plane along which the first surface 110 is aligned and a second surface along which the second surface 120 is aligned may be less than 10°, for example, less than 5°. Decreasing this angle results in a smaller width of the resulting optical element 100, 200.

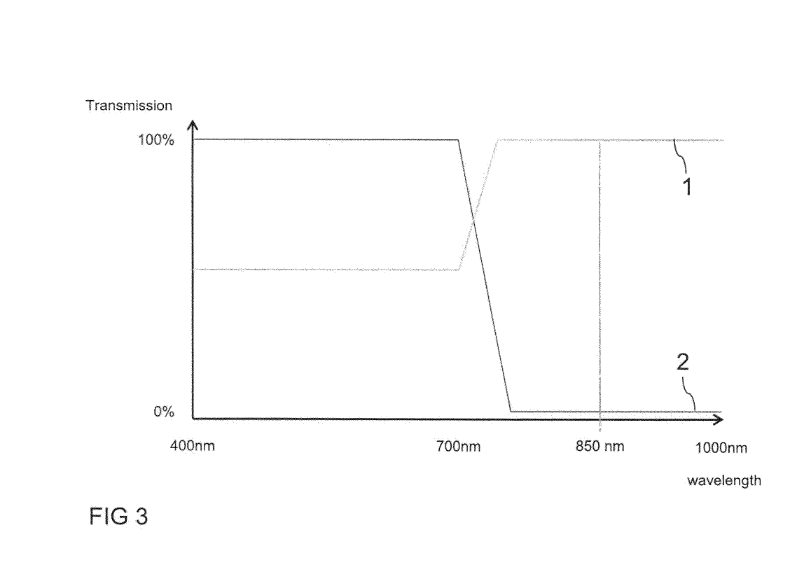

FIG. 3 illustrates the characteristics of the reflective coatings 310, 320 of the optical element 100, 200. The characteristics 1 denotes the spectral characteristic of the reflective coating 310 having a reflectivity of 50% in a wavelength range of 400 to 700 nm. As is shown, in a wavelength range of 400 to 700 nm, the reflective coating 310 reflects 50% and transmits 50% of the irradiated intensity. Moreover, in a wavelength range larger than approximately 770 nm, 100% of the irradiated intensity is transmitted. Moreover, the spectral characteristic of the reflective coating 320 is denoted as 2. In a spectral range of 400 to 700 nm, 100% of the irradiated intensity are transmitted. In a wavelength range greater than 800 nm, for example, 800 to 1100 nm, approximately 5% of the irradiated intensity are transmitted and about 95% or more of the irradiated intensity are reflected. As is shown, the reflective coating 320 has a very large transmission of more than 80%, for example, 100% in the first wavelength range. Moreover, the first reflective coating 310 has a very large transmission of more than 80%, for example, 100% in the second wavelength range.

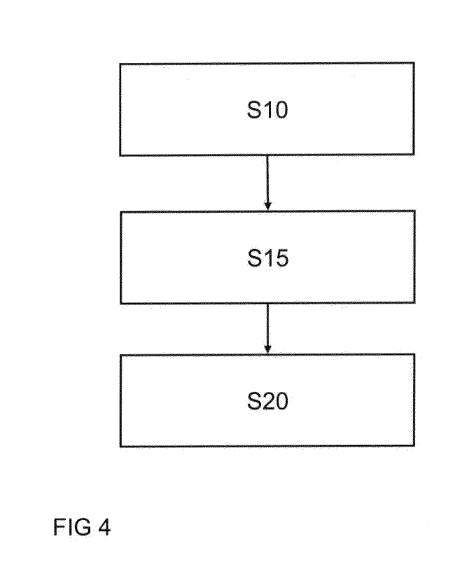

FIG. 4 illustrates a method of processing a light beam. As is shown, a method of processing a light beam comprises reflecting a first portion of the light beam at a first angle depending on a first wavelength of the first portion (S10), reflecting a second portion of the light beam at a second angle, the second angle depending on a wavelength of the second portion (S15), and transmitting a further portion of the incident light beam having a wavelength in the first wavelength range (S20).

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

### CROSS-REFERENCE TO RELATED APPLICATIONS

The present application claims priority of EP patent application No. 12 006 640.2 filed on 21 Sep. 2012, the entire contents of which are incorporated herein by reference.

1. An optical element, comprising:
a first surface with a first reflective coating, wherein a first reflectivity of the first reflective coating is greater than 0 and smaller than or equal to 100% in a first wavelength range, and
a second surface with a second reflective coating, wherein a second reflectivity of the second reflective coating is greater than 0 and smaller than or equal to 100% in a second wavelength range, wherein a portion of the second wavelength range does not lie in the first wavelength range and the first and second surface are aligned along a first and a second plane, respectively, the first and second plane intersecting at an angle smaller than 90° and larger than 0°.

2. The optical element according to claim 1, wherein the first reflectivity is 30 to 70%.

3. The optical element according to claim 1, wherein the second reflectivity is larger than 90%.

4. The optical element according to claim 1, wherein the angle a is smaller than 10°.

5. The optical element according to claim 4, wherein the angle is smaller than 5°.

6. The optical element according to claim 1, wherein the first wavelength range comprises the visible wavelength range from 400 to 700 nm.

7. The optical element according to claim 1, wherein the second wavelength range is larger than 800 nm.

8. An optical compound element comprising a first optical element according to claim 1, further comprising a second optical element which is combined with the first optical element to form a plane parallel prism configuration.

9. An optical system, comprising:
an optical compound element according to claim 8, a light reflection side of the optical compound element being defined by a side of the optical compound element at a light entrance side, a light transmitting side being defined by a side of the optical compound element opposed to the light reflection side,
a first sensor and a second sensor, both being disposed at a light reflection side of the optical element, and
a third sensor being disposed at a light transmitting side of the optical compound element, wherein the first and third sensors are operable in the first wavelength range, and the second sensor is operable in the second wavelength range.

10. The optical system according to claim 9, wherein a first direction is defined by the light entrance direction, the first and the second sensors being offset to each other along the first direction.

11. The optical system according to claim 9, wherein the second sensor is the three-dimensional sensor.

12. The optical system according to claim 11, wherein the second sensor is a TOF (Time-of-Flight) camera.

13. A method of processing a light beam, comprising:
reflecting a first portion of the light beam at a first angle depending on a first wavelength of the first portion;
reflecting a second portion of the light beam at a second angle, the second angle depending on a wavelength of the second portion; and
transmitting a further portion of the incident light beam having a wavelength in the first wavelength range.
